(19) United States
(12) Patent Application Publication
(10) Pub. No.: US 2013/0049474 A1
(43) Pub. Date: Feb. 28, 2013

(54) POWER SWITCHING APPARATUS AND A POWER SUPPLY SYSTEM INCORPORATING THE SAME

(71) Applicant: Fu-Hsing Young, Taipei (TW)

(72) Inventor: Fu-Hsing Young, Taipei (TW)

(21) Appl. No.: 13/591,071

(22) Filed: Aug. 21, 2012

(30) Foreign Application Priority Data
Aug. 23, 2011 (TW) 100215714

(51) Int. Cl. H02J 4/00

(52) U.S. Cl. 307/72

(57) ABSTRACT

A power switching apparatus includes first and second input terminals respectively coupled to a commercial power supply and a renewable energy power supply, an output terminal, a switch unit and a control unit. The switch unit can establish electrical connection between the output terminal and one of the first and second input terminals. The control unit detects a residual capacity of the renewable energy power supply, and controls the switch unit to establish electrical connection between the output terminal and the second input terminal when the residual capacity is not smaller than a predetermine threshold, and to establish electrical connection between the output terminal and the first input terminal when otherwise.

### CROSS-REFERENCE TO RELATED APPLICATION

This application claims priority of Taiwanese application no. 100215714, filed on Aug. 23, 2011.

### BACKGROUND OF THE INVENTION

1. Field of the Invention

This invention relates to a power switching apparatus, more particularly to a power switching apparatus for switching between a commercial power supply and a renewable energy power supply.

2. Description of the Related Art

Due to the continued price rising of petroleum and global energy crisis, much attention has been paid recently to the research of renewable energy, such as solar energy, wind energy, geothermal energy, tidal energy, etc. Nowadays, a power supply utilizing renewable energy may be combined with a commercial power supply for better energy usage efficiency. Therefore, if there can be a power switching apparatus to switch between a renewable energy power supply and a commercial power supply, and to fully utilize renewable energy without the need to modify existing wiring of the commercial power supply (e.g., mains electricity), it will be beneficial to the environment in terms of energy conservation.

### SUMMARY OF THE INVENTION

Therefore, the object of this invention is to provide a power switching apparatus for switching between a renewable energy power supply and a commercial power supply for fully utilizing renewable energy. Another object of this invention is to provide a power supply system incorporating the power switching apparatus and taking the renewable energy power supply as a priority power source over a commercial power supply.

According to one aspect of this invention, a power switching apparatus includes a first input terminal, a second input terminal, an output terminal, a switch unit, and a control unit. The first input terminal is adapted to be electrically coupled to a commercial power supply. The second input terminal is adapted to be electrically coupled to a renewable energy power supply. The switch unit is electrically coupled to the first input terminal, the second input terminal and the output terminal, and is capable of establishing electrical connection between the output terminal and one of the first and second input terminals.

The control unit is electrically coupled to the switch unit and second input terminal, and is configured to detect a residual capacity of the renewable energy power supply. The control unit is able to control the switch unit to establish electrical connection between the output terminal and second input terminal so as to enable output of energy from the renewable energy power supply at the output terminal upon detecting that the residual capacity of the renewable energy power supply is not smaller than a first predetermined threshold. The control unit is further able to control the switch unit to establish electrical connection between the output terminal and first input terminal so as to enable output of energy from the commercial power supply at the output terminal when otherwise.

According to another aspect of this invention, there is provided a power supply system incorporating a renewable energy power supply capable of supplying energy that comes from a renewable energy source, and the aforementioned power switching apparatus.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic block diagram of a power supply system incorporating a power switching apparatus according to the first preferred embodiment of this invention;

FIG. 2 is a circuit diagram of the power switching apparatus according to the first preferred embodiment with some elements omitted for the sake of brevity; and

FIG. 3 is a schematic block diagram of a power supply system incorporating a power switching apparatus according to the second preferred embodiment this invention.

### DETAILED DESCRIPTION OF THE PREFERRED EMBODIMENTS

Before the present invention is described in greater detail with reference to the preferred embodiments, it should be noted that the same reference numerals are used to denote the same elements throughout the following description.

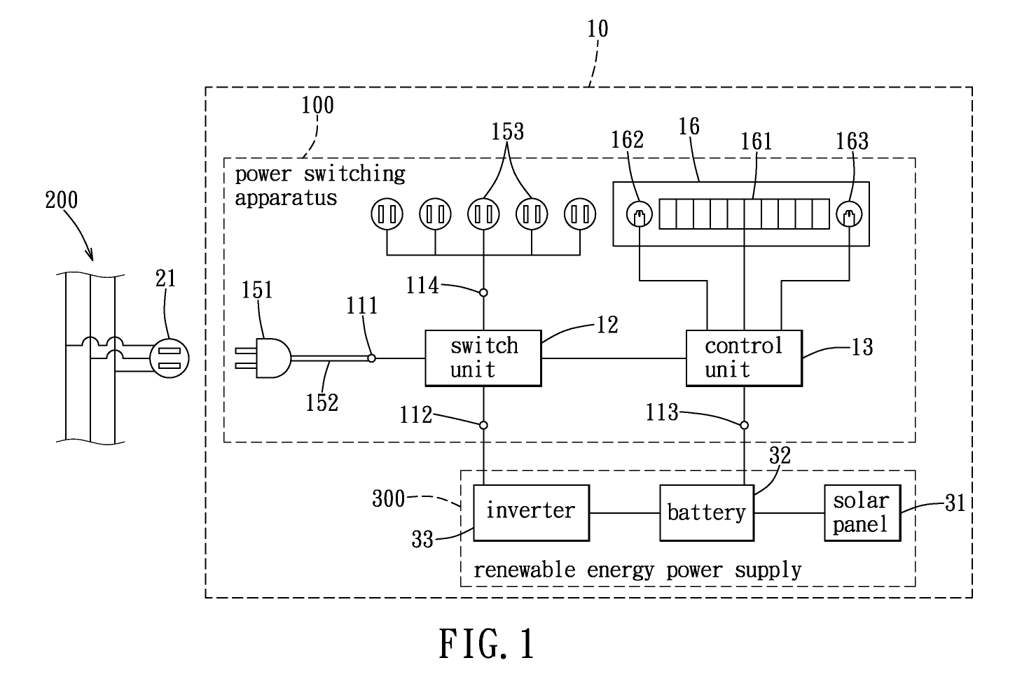

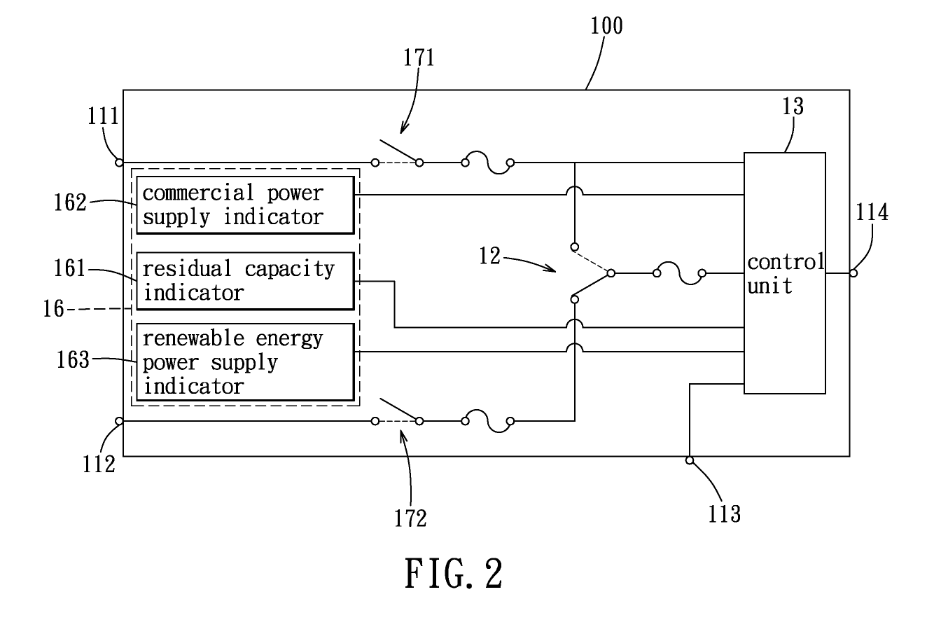

As shown in FIGS. 1 and 2, according to the first preferred embodiment of this invention, a power supply system 10 includes a power switching apparatus 100 and a renewable energy power supply 300, and is adapted to be electrically coupled to a commercial power supply 200. Specifically, the power switching apparatus 100 is adapted to be electrically coupled to the commercial power supply 200 and the renewable energy power supply 300. The renewable energy power supply 300 includes a solar panel 31 capable of converting solar energy to electric energy, a battery 32 for storing the electric energy converted by the solar panel 31, and an inverter 33 electrically coupled to the battery 32 for performing DC to AC conversion on the energy stored in the battery 32. The solar panel 31 can be replaced by other renewable energy converters in other embodiments of this invention. In this embodiment, the power switching apparatus 100 includes a first input terminal 111, a second input terminal 112, a third input terminal 113, an output terminal 114, a switch unit 12, a control unit 13, a power plug 151, a power cable 152, and a plurality of power sockets 153.

The power plug 151 is adapted to be plugged into a socket 21 of the commercial power supply 200, and the power cable 152 is electrically coupled between the power plug 151 and the first input terminal 111 for establishing electrical connection between the commercial power supply 200 and the first input terminal 111. The inverter 33 of the renewable energy power supply 300 is electrically coupled to the second input terminal 112 such that the power switching apparatus 100 may obtain electric power stored in the battery 32 of the renewable energy power supply 300 after DC to AC conversion. The third input terminal 113 is electrically coupled between the control unit 13 and the battery 32 for the control unit 13 to detect the residual capacity of the battery 32. The power socket 153 is electrically coupled to the output terminal 114 of the power switching apparatus 100 such that the output terminal 114 may output energy from the commercial power supply 200 or the renewable energy power supply 300 via the power socket 153 to an external load (not shown).

The switch unit 12 is electrically coupled to the first input terminal 111, the second input terminal 112 and the output terminal 114, and is capable of establishing electrical connection between the output terminal 114 and one of the first input terminal 111 and the second input terminal 112. It is noted herein that two slightly different implementations of the first preferred embodiment are shown respectively in FIG. 1 and FIG. 2, where in FIG. 1, the switch unit 12 is directly coupled to the output terminal 114, and in FIG. 2, the switch unit 12 is indirectly coupled to the output terminal 114 via the control unit 13. As one skilled in the art would readily appreciate these variations, as well as modifications thereof, this invention should not be limited in this aspect.

As mentioned above, the control unit 13 is electrically coupled to the battery 32 via the third input terminal 113, and is configured to detect the residual capacity of the battery 32 of the renewable energy power supply 300. The control unit 13 is further coupled electrically to the switch unit 12, and controls the switch unit 12 to establish electrical connection between the output terminal 114 and the second input terminal 112 so as to enable output of the energy from the renewable energy power supply 300 at the output terminal 114 upon detecting that the residual capacity of the battery 32 of the renewable energy power supply 300 is not smaller than a first predetermined threshold (such as 30% of the full capacity of the battery 32). The control unit 13 controls the switch unit 12 to establish electrical connection between the output terminal 114 and the first input terminal 111 so as to enable output of energy from the commercial power supply 200 at the output terminal 114 when otherwise. More specifically, the control unit 13 controls the switch unit 12 to establish electrical connection between the output terminal 114 and the second input terminal 112 so as to enable output of energy from the renewable energy power supply 300 at the output terminal 114 upon detecting that the residual capacity of the battery 32 is not smaller than a second predetermined threshold greater than the first predetermined threshold (such as 70% of the full capacity of the battery 32) and until it is detected thereby that the residual capacity of the battery 32 is smaller than the first predetermined threshold (such as 30% of the full capacity of the battery 32), and the control unit 13 controls the switch unit 12 to establish electrical connection between the output terminal 114 and the first input terminal 111 so as to enable output of energy from the commercial power supply 200 at the output terminal 114 when otherwise.

The control unit 13 is further coupled electrically to the first input terminal 111, and is configured to detect an electric potential of the commercial power supply 200. The control unit 13 controls the switch unit 12 to establish electrical connection between the output terminal 114 and the second input terminal 112 so as to enable output of the energy from the battery 32 of the renewable energy power supply 300 upon detecting that the commercial power supply 200 is off. In this case, the control unit 13 may control the switch unit 12 to establish electrical connection between the output terminal 114 and the first input terminal 111 so as to enable output of the energy from the commercial power supply 200 upon detecting that the residual capacity of the battery 32 is smaller than a third predetermined threshold, which is smaller than the first predetermined threshold (such as 10% of the full capacity of the battery 32). In this sense, the power switching apparatus 100 of this invention is designed with an attempt to uninterruptedly supply energy when power outage of the commercial power supply 200 is experienced, even when the residual capacity of the battery 32 of the renewable energy power supply 300 might be smaller than the first predetermined threshold.

In this embodiment, the power switching apparatus 100 further includes an indicator unit 16 that includes a residual capacity indicator 161, a commercial power supply indicator 162, and a renewable energy power supply indicator 163. These indicators 161, 162, 163 are electrically coupled to and controlled by the control unit 13. The residual capacity indicator 161 is configured to indicate the residual capacity of the battery 32 as detected by the control unit 13. The commercial power supply indicator 162 and the renewable energy power supply indicator 163 are respectively configured to indicate whether the power switching apparatus 100 is currently outputting energy from the commercial power supply 200 or from the renewable energy power supply 300.

In this embodiment, the power switching apparatus 100 further includes a first switch component 171 connected between the first input terminal 111 and the switch unit 12, and a second switch component 172 connected between the second input terminal 112 and the switch unit 12. The first and second switch components 171, 172 are manually switchable for a user to cut off supply of energy from the commercial power supply 200 and the renewable energy power supply 300, respectively. It is noted that the first and second switch components 171, 172 are omitted in FIG. 1.

It is noted that the power switching apparatus 100 of this invention is equipped with the power plug 151 for electrical connection to the commercial power supply 200 via the socket 21, and is further equipped with the power sockets 153 for electrical connection to external loads (not shown). Therefore, the power switching apparatus 100 of this invention is ready to use with the commercial power supply 200 without the need to change any wiring.

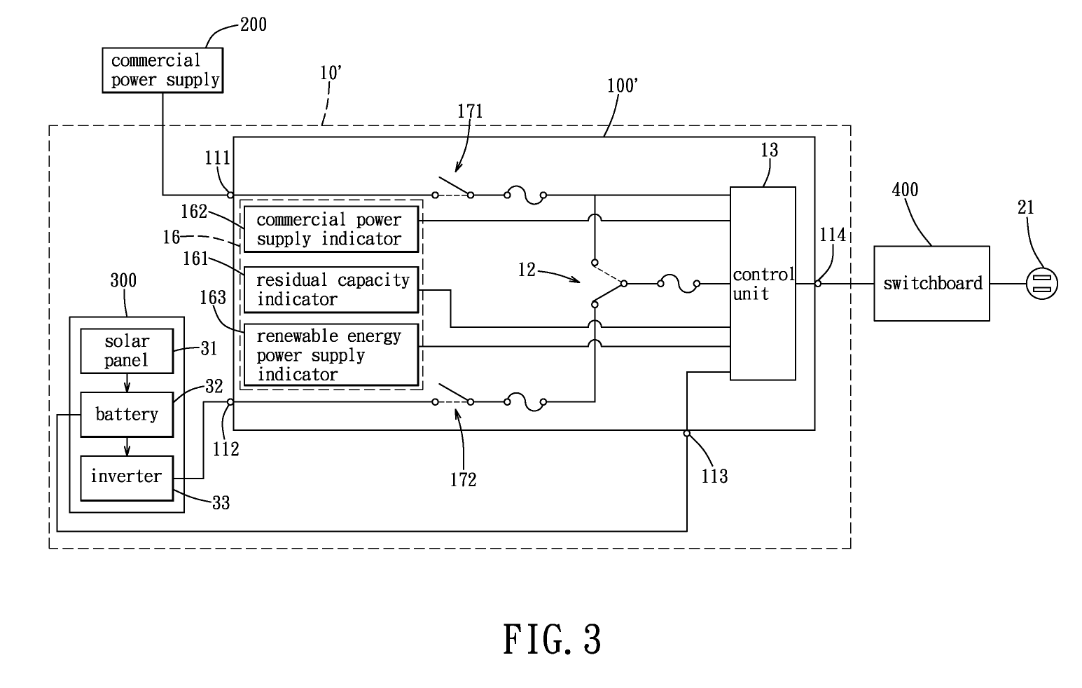

FIG. 3 shows a power supply system 10′ incorporating a power switching apparatus 100′ according to the second preferred embodiment of this invention. The second preferred embodiment differs from the first preferred embodiment in that the power plug 151 and the power cable 152 are excluded in the second preferred embodiment such that the first input terminal 111 of the power switching apparatus 100 is directly and electrically coupled to the commercial power supply 200, that the power sockets 153 are also excluded in the second preferred embodiment, and that the output terminal 114 of the power switching apparatus 100′ is electrically coupled to a switchboard 400, which is electrically coupled to the socket 21 of the commercial power supply 200, such that when an external load (not shown) is plugged into the socket 21 of the commercial power supply 200, the power switching apparatus 100′ of this invention enables the external load to use the energy from the renewable energy power supply 300 when the residual capacity of the battery 32 of the renewable energy power supply 300 is not smaller than the second predetermined threshold (e.g., 70% of the full capacity) and until the residual capacity of the battery 32 is smaller than the first predetermined threshold (e.g., 30% of the full capacity), and to only use the energy from the commercial power supply 200 when otherwise. Through this mechanism, this invention ensures that use of renewable energy has higher priority over commercial energy when renewable energy is available.

In summary, according to this invention, with the control unit 13 controlling the switch unit 12, energy from the renewable energy power supply 300 may be used in priority over the commercial power supply 200 so as to diminish the use of commercial power supply 200 and achieve the objective of energy conservation. Moreover, in accordance with one implementation of this invention, the power switching apparatus 100 is equipped with the power plug 151 to be readily plugged into the socket 21 of the commercial power supply 200, and is equipped with at least one power socket 153 for convenient plugging by an external load without the need to modify wiring of the commercial power supply 200. In addition, in accordance with another implementation of this invention, the power switching apparatus 100′ is coupled electrically to the socket 21 of the commercial power supply 200 and when an external load is plugged into the socket 21, the power switching apparatus 100′ may function to output the energy of the renewable energy power supply 300 instead of the energy from the commercial power supply 200 when conditions are met as described above.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A power switching apparatus comprising:
a first input terminal adapted to be electrically coupled to a commercial power supply;
a second input terminal adapted to be electrically coupled to a renewable energy power supply;
an output terminal;
a switch unit electrically coupled to said first input terminal, said second input terminal and said output terminal, and capable of establishing electrical connection between said output terminal and one of said first and second input terminals; and
a control unit electrically coupled to said switch unit and said second input terminal, and configured to detect a residual capacity of the renewable energy power supply, said control unit controlling said switch unit to establish electrical connection between said output terminal and said second input terminal so as to enable output of energy from the renewable energy power supply at said output terminal upon detecting that the residual capacity of the renewable energy power supply is not smaller than a first predetermined threshold, and controlling said switch unit to establish electrical connection between said output terminal and said first input terminal so as to enable output of energy from the commercial power supply at said output terminal when otherwise.

2. The power switching apparatus as claimed in claim 1, wherein said control unit controls said switch unit to establish electrical connection between said output terminal and said second input terminal so as to enable output of energy from the renewable energy power supply at said output terminal upon detecting that the residual capacity of the renewable energy power supply is not smaller than a second predetermined threshold, which is greater than the first predetermined threshold, and until it is detected thereby that the residual capacity of the renewable energy power supply is smaller than the first predetermined threshold, said control unit controlling said switch unit to establish electrical connection between said output terminal and said first input terminal so as to enable output of energy from the commercial power supply at said output terminal when otherwise.

3. The power switching apparatus as claimed in claim 2, wherein said control unit is further coupled electrically to said first input terminal, and is configured to detect an electric potential of the commercial power supply, said control unit controlling said switch unit to establish electrical connection between said output terminal and said second input terminal so as to enable output of energy from the renewable energy power supply upon detecting that the commercial power is off.

4. The power switching apparatus as claimed in claim 3, wherein said control unit controls said switch unit to establish electrical connection between said output terminal and said second input terminal upon detecting that the commercial power supply is off and until it is detected thereby that the residual capacity of the renewable energy power supply is not greater than a third predetermined threshold, which is smaller than the first predetermined threshold.

5. The power switching apparatus as claimed in claim 1, further comprising a power plug adapted to be plugged into a socket of the commercial power supply, a power cable coupled electrically between said power plug and said first input terminal, and a power socket electrically coupled to said output terminal, said output terminal outputting energy from one of the commercial power supply and the renewable energy power supply via said power socket to an external load.

6. The power switching apparatus as claimed in claim 1, further comprising a residual capacity indicator that is electrically coupled to said control unit and that is configured to indicate the residual capacity of the renewable energy power supply.

7. The power switching apparatus as claimed in claim 1, further comprising a first switch component connected between said first input terminal and said switch unit, and a second switch component connected between said second input terminal and said switch unit.

8. The power switching apparatus as claimed in claim 7, wherein said first and second switch components are manually switchable.

9. A power supply system comprising:
a renewable energy power supply capable of supplying energy that comes from a renewable energy source;
a power switching apparatus including
a first input terminal that is adapted to be electrically coupled to a commercial power supply,
a second input terminal that is electrically coupled to said renewable energy power supply,
an output terminal,
a switch unit that is electrically coupled to said first input terminal, said second input terminal and said output terminal, and that is capable of establishing electrical connection between said output terminal and one of said first and second input terminals, and
a control unit that is electrically coupled to said switch unit and said second input terminal, and that is configured to detect a residual capacity of said renewable energy power supply, said control unit controlling said switch unit to establish electrical connection between said output terminal and said second input terminal so as to enable output of the energy from said renewable energy power supply at said output terminal upon detecting that the residual capacity of said renewable energy power supply is not smaller than a first predetermined threshold, and controlling said switch unit to establish electrical connection between said output terminal and said first input terminal so as to enable output of energy from the commercial power supply at said output terminal when otherwise.

10. The power supply system as claimed in claim 9, wherein said control unit of said power switching apparatus controls said switch unit to establish electrical connection between said output terminal and said second input terminal so as to enable output of the energy from said renewable energy power supply at said output terminal upon detecting that the residual capacity of said renewable energy power supply is not smaller than a second predetermined threshold, which is greater than the first predetermined threshold, and until it is detected thereby that the residual capacity of said renewable energy power supply is smaller than the first predetermined threshold, said control unit controlling said switch unit to establish electrical connection between said output terminal and said first input terminal so as to enable output of energy from the commercial power supply at said output terminal when otherwise.

11. The power supply system as claimed in claim 10, wherein said control unit of said power switching apparatus is further coupled electrically to said first input terminal, and is configured to detect an electric potential of the commercial power supply, said control unit controlling said switch unit to establish electrical connection between said output terminal and said second input terminal so as to enable output of the energy from said renewable energy power supply upon detecting that the commercial power is off.

12. The power supply system as claimed in claim 11, wherein said control unit of said power switching apparatus controls said switch unit to establish electrical connection between said output terminal and said second input terminal upon detecting that the commercial power supply is off and until it is detected thereby that the residual capacity of said renewable energy power supply is not greater than a third predetermined threshold, which is smaller than said first predetermined threshold.

13. The power supply system as claimed in claim 9, wherein said power switching apparatus further includes a power plug adapted to be plugged into a socket of the commercial power supply, a power cable coupled electrically between said power plug and said first input terminal, and a power socket coupled electrically to said output terminal, said output terminal of said power switch unit outputting energy from one of the commercial power supply and said renewable energy power supply via said power socket to an external load.

14. The power supply system as claimed in claim 9, wherein said power switching apparatus further includes a residual capacity indicator that is electrically coupled to said control unit and that is configured to indicate the residual capacity of said renewable energy power supply as detected by said control unit.

15. The power supply system as claimed in claim 9, wherein said renewable energy power supply includes a battery for storing the energy obtained from the renewable energy source, and an inverter coupled electrically to said battery for performing DC to AC conversion on the energy stored in said battery, said second input terminal of said power switching apparatus being coupled electrically to said inverter, said power switching apparatus further including a third input terminal coupled electrically between said control unit and said battery of said renewable energy power supply so as to permit said control unit to detect the residual capacity of said renewable energy power supply.
